(19) United States
(12) Patent Application Publication
(10) Pub. No.: US 2026/0279086 A1
(43) Pub. Date: Sep. 17, 2026

(54) TEXT RECOGNITION SYSTEM AND METHOD

(71) Applicant: Sony Interactive Entertainment Inc., Tokyo (JP)

(72) Inventor: Simon Andrew St. John Brislin, London (GB)

(21) Appl. No.: 19/565,243

(22) Filed: Mar. 12, 2026

(30) Foreign Application Priority Data
Mar. 13, 2025 (GB) 2503682.3

(51) Int. Cl. G06V 30/14; G06V 20/62; G06V 30/18; G06V 30/19

(52) U.S. Cl. CPC G06V 30/1448; G06V 20/62; G06V 30/18105; G06V 30/1914

(57) ABSTRACT

A system and method for obtaining a plurality of image frames from video content during presentation, the plurality of image frames comprising every n^{th} frame of the content where n is an integer greater than one, identifying, in an obtained image frame, one or more regions in which text may appear, and selectively performing an OCR process in the one or more bounding areas in which the threshold size is exceeded for at least a predetermined number of consecutive frames, and to output recognised text.

### CROSS-REFERENCE TO RELATED APPLICATIONS

This application claims priority to United Kingdom Application No. 2503682.3, filed on Mar. 13, 2025, the contents of which are incorporated herein by reference.

### FIELD OF THE INVENTION

This disclosure relates to a text recognition system and method.

### BACKGROUND

Optical character recognition (OCR) is a type of process in which text is able to be extracted from images; this can be implemented using any one of a number of different techniques which convert image content to corresponding text. Such processes are advantageous in that they enable the extraction of context about an image based upon the textual information that is present; once extracted, the text can also be manipulated in a more efficient manner for further processing (such as keyword recognition or event detection).

While OCR techniques can be considered to be useful, the processing requirements associated with such techniques are significant. This can be true for analysis of any given frame, and as such performing OCR techniques on video can be particularly burdensome. For instance, in a sixty frames per second video the analysis would be required to be performed sixty times a second for a live OCR implementation. It is therefore desirable to reduce this burden where possible.

It is in the context of the above discussion that the present disclosure arises.

### SUMMARY

In general, in a first aspect, the disclosure features a system for performing an optical character recognition, OCR, process, the system including: a frame obtaining unit configured to obtain a plurality of image frames from video content during presentation, the plurality of image frames including every n^{th} frame of the content where n is an integer greater than one; a region identification unit configured to identify, in an obtained image frame, one or more regions in which text may appear; a region modification unit configured to apply one or more color ranges to the identified regions such that colors outside of the color ranges are set to a default value, wherein the color ranges are defined based upon expected text colors; a text presence identification unit configured to identify the presence of text within the identified regions, and to identify the size of one or more bounding areas which each correspond with a respective identified text presence; a bounding area evaluation unit configured to determine whether any of the one or more bounding areas exceeds a threshold size, wherein if it is determined that none of the bounding areas exceeds the threshold size then processing continues with the region identification unit identifying one or more regions in the next obtained image frame; a monitoring unit configured to cause, if it is determined that at least one bounding area exceeds a threshold size, the frame obtaining unit to instead obtain a plurality of consecutive frames of content, and to monitor a number of consecutive frames in which the bounding area exceeds the threshold size; and an OCR unit configured to perform an OCR process in the one or more bounding areas in which the threshold size is exceeded for at least a predetermined number of consecutive frames, and to output recognised text. Additional aspects and features of the disclosure are defined in the description below, the drawings, and appended claims.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment system;

FIG. 2 schematically illustrates an OCR method;

FIG. 3 schematically illustrates a region of interest detection process;

FIG. 4 schematically illustrates a text color detection process;

FIG. 5 schematically illustrates a system for performing an optical character recognition process; and

FIG. 6 schematically illustrates a method for performing an optical character recognition process.

### DETAILED DESCRIPTION

Referring now to the drawings, wherein like reference numerals designate identical or corresponding parts throughout the several views, embodiments of the present disclosure are described.

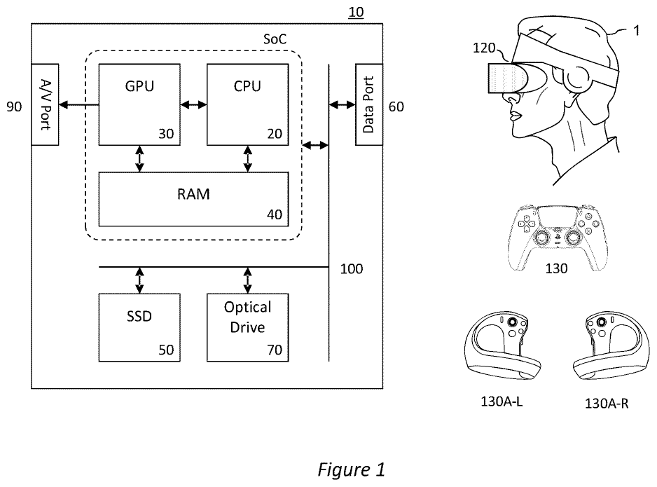

Referring to FIG. 1, an example of an entertainment system 10 is a computer or console.

The entertainment system 10 includes a central processor or CPU 20. The entertainment system also includes a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’120, worn by a user 1.

Interaction with the system is typically provided using one or more handheld controllers 130, and/or one or more VR controllers (130A-L, R) in the case of the HMD.

The entertainment system 10 of FIG. 1 is an example of a hardware device that is configured to implement text recognition methods according to the present disclosure. For instance, an optical character recognition (OCR) process in line with those which are disclosed may be executed by the GPU 30 and/or CPU 20.

Methods described in this document seek to reduce the burden associated with OCR by performing such processing in a more targeted manner. A number of approaches for reducing this burden are disclosed, each of which can be used in isolation or in combination with one or more of the other approaches as appropriate.

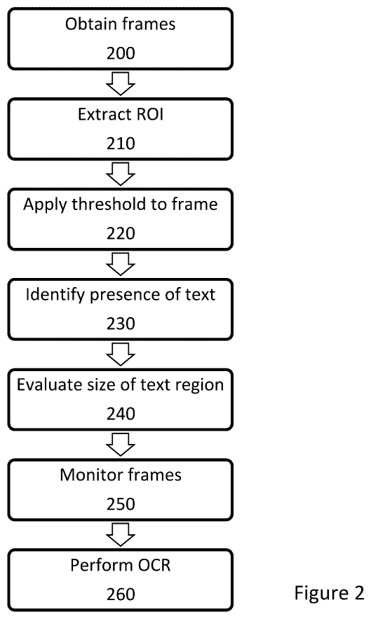

FIG. 2 schematically illustrates a method according to implementations of the present disclosure, with this method providing an efficient and effective manner of performing an optical character recognition process on video content. It will be appreciated that the steps shown here are exemplary, and that modifications to these steps or additional steps may be utilised as appropriate for a given implementation.

A step 200 includes obtaining frames of the video content; while this may be every frame of the content that is obtained, it is preferred that every n^{th} frame is obtained (where n is an integer greater than one). By selecting a higher value for n, the number of frames that are subjected to processing is able to be reduced (thereby increasing efficiency of the method). In some examples, n may be equal to two or three-while in others a higher value such as five, ten, or thirty may be preferred.

The value for n that is to be used can be selected freely, and may be selected in dependence upon factors such as the frame rate of the content and information indicating the average or minimum text display times within the content. For instance, as the frame rate increases the selected value of n may also increase as the elapsed time can be kept constant-for instance, doubling the frame rate whilst also doubling the value of n will mean that the time between frame samplings is the same. Similarly, in the case that text is displayed for a long time on average (or the shortest display time for text is relatively long) a higher value of n may be adopted as the chance of missing text due to infrequent sampling is reduced.

A step 210 includes identifying and extracting possible regions of interest (ROIs) within obtained frames. The ROIs may be any portions of an image frame in which text may be expected to appear, or at least in which it is possible for text to appear. This may be based upon prior evaluation of content from the same source (such as a video game, or a content distributor which provides annotations/overlays on content), for example, or based upon parameters which define text placement within content from a given source. Information about the possible ROIs can be provided in any suitable format, such as a text file which defines regions (such as an image region which corresponds to boxes in which text can appear) or an image file which defines a mask indicating such regions.

A step 220 includes applying color thresholds to the extracted regions of interest to seek to isolate text in that region. These thresholds can be defined based upon information about font colors used in the content; this can be on a region-specific basis where appropriate, although it may be sufficient that the thresholds are defined for the content as a whole. A single pair of thresholds may be used which are defined so as to cover the entire range of possible text colors (with each threshold including multiple components where appropriate, such as RGB or HSV components). However, it may be preferable to instead define different thresholds on a per-color or per-color-group so as to isolate possible text more precisely (despite the use of a single pair of thresholds being more computationally efficient).

Of course, simply defining the text colors (rather than using thresholds) may be sufficient in a number of cases-however it is considered that the colors may be varied during rendering by display effects (such as shadows or other lighting) and as such a threshold-based approach may be preferred to allow the process to be resilient to such variations.

Applying the thresholds to a given frame includes setting any values outside of the threshold range (or ranges) to a single color (typically black, but any non-text color may be considered). Additionally, any values within the threshold range (or ranges) may be set to a single color (such as white, or any other color which allows a good contrast with the background/non-text color).

At a step 230, a process is performed which identifies the presence of text within the extracted ROIs. This can be performed in any of a number of different ways. In a first example, the presence of text can be identified by evaluating whether there are any non-black (or other outside-threshold color from step 220) pixels within an extracted ROI. More sophisticated approaches can utilise a method which evaluates the region in a more detailed fashion-while this may be more computationally expensive, this can reduce the likelihood of performing OCR in an ROI which does not contain text and thereby improve overall efficiency of the method.

An example of such a method is the use of the maximally stable extremal regions (MSER) technique. MSER is a technique which is used for blob detection in images, and can be used to detect objects that look like text-such as a series of small shapes in a line (letters in a sentence). Any other processing techniques may also be considered which allow a similar effect to be achieved; that is, the effect of identifying the presence of text without seeking to read extract the text.

A step 240 includes an evaluation of the size of the text region; should the size of the text region exceed a given threshold (for instance, threshold width, height, or area), then it can be assumed that the region does actually include text. If the threshold is not exceeded, then it is considered that the processing in step 230 has identified a non-text input which has some superficial similarity to text. The threshold can be defined based upon known text properties (such as the shortest displayed message in the content, for instance), and can be defined for the content or on a per-region basis as preferred.

If the size of the text region does meet or exceed a corresponding threshold value, then processing proceeds to step 250. In the alternative, the method returns to step 200.

Step 250 includes monitoring a plurality of consecutive frames to detect whether the region exceeding the width threshold is present within a plurality of frames. This enables an identification of the text as a persistent object-a property that is well-defined for text, as it is understood that text can have a degree of temporal persistence to allow the viewer time to read the text. The number of frames for which the detection can be successful to proceed to step 260 can be determined freely-in some cases, it may be desirable to determine the number of frames on the basis of information about the minimum or typical duration for which text is displayed within content.

In some implementations, the process may be modified such that rather than obtaining every n^{th} frame instead a greater number of frames is used for step 250 (and optionally, step 260). This is achieved by using a value of n that is lower than that selected for step 200; in some cases, the value selected for n may be one such that every frame is obtained and used for monitoring. Of course, the number of frames for which the detection can be successful is able to be selected in accordance with this updated value for n.

At a step 260, any extracted regions for which text is identified as being a persistent feature are subjected to an OCR process to extract text from those regions. Any suitable OCR process may be used, rather than being limited to any particular implementation. The efficiency of this OCR process is enhanced through the reduction in both the number of times it is executed and the amount of a given image frame that it is applied to. The OCR process may be applied to a single extracted region, from any of the number of frames which are monitored. It may be preferable to use the extracted region from the most recent frame, for instance, but this is not required as any of the frames showing the persistent text is suitable.

Optionally, the results of the OCR process may be compared to a content-or region-specific dictionary to confirm that the results are valid. This dictionary may be an exhaustive list of all words that can appear in the content/region, or may represent a subset of keywords. In some implementations, the dictionary may include a plurality of keywords which are respectively representative of one of each of the possible phrases (such as ‘ammo’ being representative of the phrase ‘supplies of ammo are running low’). Alternatively, or in addition, the dictionary may include phrases (or other multi-word text strings) that appear within the content/region such that the extracted text can be compared directly to possible text string values.

In some cases, the OCR process may generate an output that misreads one or more letters-in such cases, the dictionary can be used to identify the correct text and this can instead be used as the OCR output. In order to match the incorrect OCR output and a matching dictionary entry, any suitable process can be used; in one example, the Levenshtein distance is used as a metric to determine similarity (whereby an above-threshold similarity is sufficient to consider them a match). The Levenshtein distance is a specific example of a metric which measures the number of changes to edit the input into the output-however any other methods for determining similarity between text strings may be employed.

In the case that no match is found between the OCR results and the dictionary, no output of the extracted text is performed as it is considered that the OCR result is erroneous.

In response to the results of the OCR process being validated (or in response to the OCR being performed and text being detected, if no validation is performed), text extraction processing may be suspended until the region (or regions) from which text is extracted change sufficiently. This ensures that OCR is only performed for new text, and is not used to repeatedly extract the same text. The suspension of text extraction processing may be for a given number of frames or duration of time (based upon average or maximum text display times, for instance) rather than based upon particular monitoring for changes, and this may be implemented on a per-content or per-ROI basis. In some cases, this may be implemented on a per-text basis as the display time for a given text string may be well-defined.

Alternatively, changes in an ROI can be monitored in any of a number of different manners-for instance, step 230 can be performed in an iterative fashion with results compared to previous iterations to determine whether a change has occurred. This may be a direct comparison of results such as presumed text locations or region height/width differences. Such monitoring may be performed on the basis of every n^{th} frame (or any other subset of frames), rather than every frame as during the monitoring of step 250.

The results of the OCR process can be used in any preferred fashion-in some cases, the extracted text may be provided to the user in an alternative format (such as audio, or in an enlarged fashion). The extracted text may also be used as an input for other processes, such as external overlay generation for content which utilise the extracted text to identify the context of the content.

While the above is described with reference to performing OCR on each extracted region separately, it is of course considered that the OCR process is performed on the image frame as a whole-but only in those regions which are considered to include text. This can be achieved by defining regions for the OCR process to operate in, or by applying a mask to the image frame which will cause the OCR process to skip non-text regions.

In some implementations, the ROIs extracted in step 210 may be subjected to color space conversion processing prior to the threshold process of step 220 being implemented. This can be to convert the image frame from a first color space (such as RGB) to a preferred color space such as HSV. Operating in the HSV color space may be preferred in implementations according to the present disclosure in that perceptual uniformity is increased (and therefore overlaid text will contrast with the rest of the content more readily).

As described with reference to step 210 of FIG. 2, regions of interest are extracted from the obtained image frames. These ROIs can be defined by a developer, for instance, and can include information about the location of those ROIs within an image frame. However, it may be preferable that a more detailed approach to generating ROI information is adopted as additional information can further streamline the OCR proc ess and thereby increase processing efficiency.

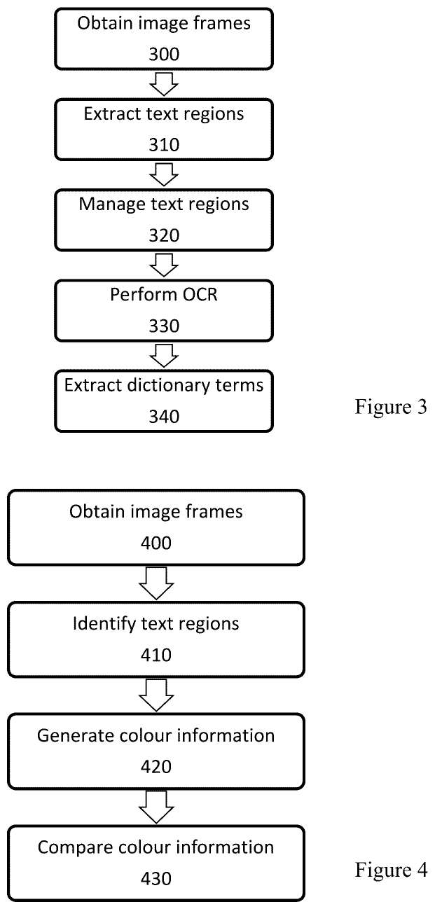

FIG. 3 schematically illustrates an ROI detection process that may be implemented in conjunction with the method of FIG. 2.

A step 300 includes obtaining image frames from the content-in the case of a video game, this may be a sample playthrough of the game, for example. Rather than using every frame of the content, a representative sample may be used-this may be a frame for every half second or full second interval, for example. Rather than using frames which are displayed at regular intervals, in some cases a random approach to obtaining frames may be taken in which the number of frames is selected on the basis of the duration of the content so as to allow the random sampling to be a representative sample. Pseudo-random sampling may also be adopted, in which (for example) random intervals are used in which the intervals are within a threshold range of values so as to reduce bunching of frames.

A step 310 includes detecting text regions and extracting them from each of the obtained image frames; this may be performed using an MSER method or the like, for instance.

A step 320 includes managing the extracted text regions. This can include discarding any that have been extracted from a below-threshold number of frames (that is, discarding text that does not appear frequently-such as rare notifications or environmental text in a game). This can be performed based upon the size/location of the text region (as this may be unique for some text), for example, or based upon the results of an OCR process which extracts the corresponding text (which can then be compared).

The step 320 may further include merging one or more text regions to reduce the number of independent regions where appropriate. This can be based upon a consideration of the overlap between different text regions; for example, two text regions may overlap to a significant degree when two messages of different lengths are commonly displayed in the same area. An example of this is if a current objective is displayed on the screen—the location may be consistent, but the size of the region may vary based upon the number of characters used to represent the objective. One measure for evaluating this is intersection over union—this is a metric which determines the ratio of the shared area for two regions and their total area, in which a higher value indicates a greater degree of overlap.

A step 330 includes performing OCR on the text regions; while shown here to be following step 320, in some implementations the management of step 320 may be dependent upon the context of text boxes and as such it is considered that this step may be performed before step 320 or substantially simultaneously.

A step 340 includes reading out the results of the OCR process into a provisional dictionary; this may be a content-specific dictionary, or it may be generated on a more specific basis such that each region is associated with its own set of dictionary terms.

This provisional dictionary is expected to include a number of duplicate entries, whereby the OCR process has incorrectly interpreted a given character or the like. For instance, ‘Level 1’ could be interpreted as ‘Level 1’ (in which the lowercase ‘L’ is interpreted as an uppercase ‘I’), each of which would appear in the provisional dictionary. Likely duplicates due to such errors can be identified using any suitable method (such as the Levenshtein distance discussed above), with the correct version of the text being identified based upon comparison to a normal dictionary (such that correctly-spelled words are prioritised) and/or a frequency with which the particular text arose (as it can be expected that OCR processes will generate the correct result more frequently than any specific incorrect result).

Another modification that can be made to the provisional dictionary to generate a final dictionary for use is that of identifying numerical fields and omitting these from the dictionary. This may be advantageous in that numerical fields can be subject to a significant variation without requiring distinct dictionary entries. For instance, ‘Level 1’ and ‘Level 2’ both convey the same information, but with a different numerical value. As such, it would be more efficient to represent this with a single dictionary entry (‘Level’) which can be combined with a numerical value for further context. Similar considerations can be made for tracking inventory supplies or the like-if a user can carry 1000 of an item in a game, then this can require a significant-sized dictionary to store the possible values.

The method of FIG. 3 therefore provides an automated identification of text locations and generation of corresponding dictionaries for those locations. This is an efficient method of generating such information, which in turn leads to a more efficient implementation of an OCR process through improving the text region identification and the region-specific dictionary elements.

FIG. 4 schematically illustrates another method which can be used to improve the efficiency and/or effectiveness of an OCR process through pre-processing of image frames for a given content.

A step 400 includes obtaining image frames from the content-in the case of a video game, this may be a sample playthrough of the game, for example. Rather than using every frame of the content, a representative sample may be used-this may be a frame for every half second or full second interval, for example. Rather than using frames which are displayed at regular intervals, in some cases a random approach to obtaining frames may be taken in which the number of frames is selected on the basis of the duration of the content so as to allow the random sampling to be a representative sample. Pseudo-random sampling may also be adopted, in which (for example) random intervals are used in which the intervals are within a threshold range of values so as to reduce bunching of frames.

A step 410 includes performing an OCR technique on obtained images so as to enable the identification of text regions within a given image. At this stage the OCR process can be a low-quality version which prioritises efficiency over accuracy, as the text itself is not essential to be used in the method of FIG. 4. Alternatively, the OCR process can be replaced by any other suitable process which detects the presence of text without extracting the text itself.

A step 420 includes generating color information for each of the identified text regions. In particular, this includes generating a first color palette which is representative of the text (as identified by the process of step 410) and a second color palette which is representative of the background near the text. These two regions can be defined in any suitable manner, with the effect being that a first color palette has a higher incidence of the text color or colors than the second color palette.

In a first example, a box is defined which surrounds a text region and the color of each of the pixels (or a subset, such as a checkerboard sample pattern) is sampled to generate a first color palette. The second color palette may then be generated in a similar fashion on the basis of a shape which follows the boundary of the box (but does not include the box). Of course, it should be ensured that this new shape does not include text from other sources due to proximity of different text regions.

Alternatively, different approaches to sampling the colors of the regions may be utilised. For instance, a k-means clustering with 4 clusters (for example; other values may be selected as appropriate for a given implementation) on all the pixels within each text box may be utilised. This generates a first palette with a reduced number of entries, each of which is representative of a larger number of pixels (such as a mean value of the pixel colors). The same process can also be applied to a region about the text box to generate the second palette.

A step 430 includes comparing the color information included within each of the color palettes. This step includes the identification of a color which best represents the difference between the first and second color palettes—this color being the text color (or at least an approximation of the text color, as the processing may mean the color is not exact). Any suitable comparison process may be performed, such as a subtraction of the second palette from the first palette (either per-component or based upon representative elements). Similarly, processing may be performed to remove colors that are duplicated between each palette with the remainder expected to be largely contributions of the text.

One process that may be utilised is that of finding a color in the first palette whose sum of differences against the background colors in the second palette is the largest. In other words, this process selects a color in the first palette which is most different from the colors in the second palette. This can be assessed using any preferred color difference metric, with one example being the Delta-E CIE 2000 formula. This color is taken as being the color of the text.

The results of the processing of step 430 may be used in any suitable manner. In some cases, the colors that are extracted are used as they are to define the text color for a given text region or added to a dictionary of possible text colors for the content itself. However, as noted above, in some cases the identified color may not be an exact match for the text color. In this case, one or more ranges can be defined for the text color. Such ranges may be defined based upon the color information in any preferred manner.

One such example is to take a set of identified colors (that is, the identified color for each text region within an image frame or a plurality of image frames), and to group the colors by their perceptual similarity to one another. Based upon the variations of the text color that are present within the group of colors, an average and a range about that average can be identified and used as the definition of the text color. A range may be based upon the standard deviation of the color values within that group, for instance.

The result is a set of color ranges that define text colors within the image frame, or for a given text region within an image frame. This can be collated on a per-content basis by applying the method to multiple image frames within the content. Any overlapping color ranges can be merged so as to reduce the number of color ranges which are stored for a given text region or image frame. These results can be used by the method of FIG. 2, for example, so as to generate the constraints upon the OCR process in an efficient and effective manner.

As an alternative, or additional, step to that of step 430, the correct text color can be identified (or confirmed) using a process in which successive versions of the image are generated using different masks. These masks define a color (or color range) which is to be preserved within an image, with everything else set to a contrasting color (alternatively, the defined color/color range may be set to a first color, such as white, while other colors are set to a second color, such as black).

Once the masks have been applied to the image, an OCR process can be performed on each masked version of the image or at least the portions of the masked images which are identified as containing text. It is expected that the OCR process would only output a result when the defined color/color range is the one that actually corresponds to the text. Alternatively, it may be considered that a correct result (that is, a correct reading of the text) will only be output when the correct color mask is used. This may be confirmed via a labelling of the corresponding area or a human supervisor, for example). Therefore, based upon the output of the OCR process it can be determined which color the text is in the corresponding image region.

The colors for the masks can be defined in any preferred manner; in one approach it is considered that the colors are defined on the basis of a k-means clustering process. In this case, the color range may encompass the entire palette that is generated, a representative color (such as the mean color value, optionally defined as a range based upon standard deviation or the like), or at least a subset of the palette (such as a most common color or colors, or a particular portion of the palette color range).

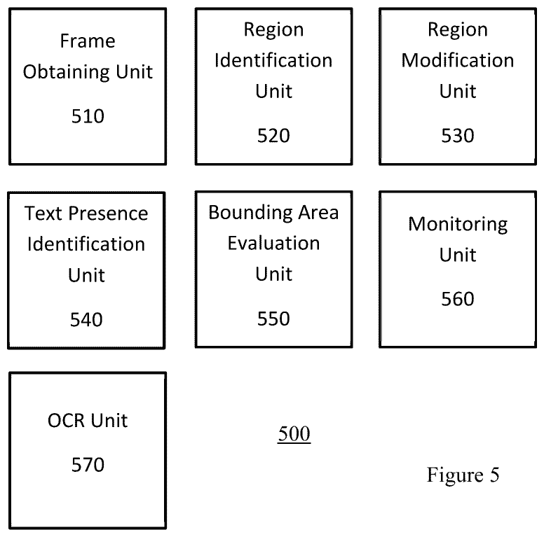

FIG. 5 schematically illustrates a system for performing an optical character recognition (OCR) process, such as the process described with reference to FIG. 2. The system 500 includes a frame obtaining unit 510, a region identification unit 520, a region modification unit 530, a text presence identification unit 540, a bounding area evaluation unit 550, a monitoring unit 560, and an OCR unit 570. The system 500 may be implemented by any suitable combination of hardware processing elements, such as CPUs and/or GPUs; these may be implemented as a part of a general-purpose computer, at a server, or as a games console (for example). The entertainment system 10 of FIG. 1 is an example of a suitable device, in that it includes a CPU 20 and a GPU 30 which can be used to implement such functionality.

The frame obtaining unit 510 is configured to obtain a plurality of image frames from video content during presentation, the plurality of image frames including every n^{th} frame of the content where n is an integer greater than one. This content may be a video game that is currently being played, for instance, or a video that is being viewed by a user.

The value of n (indicating how frequently frames are sampled) may be set to any preferred value; for instance, a value of two would mean that every other frame was being sampled. While this means that a lot of frames would be processed, this would reduce the likelihood of missing text that would otherwise be extracted from the image frames. It is considered that the value of n may be selected in dependence upon a frame rate of the content and information about the average and/or minimum display time for text within the content. In other words, information about how long text is present on the screen for may be used to determine how frequently to sample the content so as to reduce the likelihood of not detecting text.

Alternatively, or in addition, a user may be able to provide an input to determine the value of n; this may be a definition of the value, or a preference toward a higher or lower value, for instance. Similarly, information about the processing capabilities of the device which implements the system 500 may be considered when determining the value of n; a device with limited processing capabilities may utilise a higher value of n so as to reduce the processing burden. This may be preferable even in view of the increased risk of not detecting text, as it can mean a reduced impact on the presentation of the video content to the user.

The region identification unit 520 is configured to identify, in an obtained image frame, one or more regions in which text may appear (as discussed with reference to ROIs with respect to FIG. 2). This is dependent upon information which has been determined in advance for the content; this may be defined by a developer or content creator, for example, or may be derived using a process in accordance with that described with reference to FIG. 3. In some implementations, the region identification unit 520 is configured to identify the one or more regions in dependence upon a text file indicating region locations or an image mask which masks regions in which text does not appear. While the information may be defined on a per-frame basis, it may be preferred that it is defined on a per-content basis such that the information represents all of the possible locations for text throughout the content. While the information may indicate all of the possible locations for text, it may be preferred that only a subset of the possible locations is identified—this may be based on a threshold frequency, for instance, or based upon the importance of the text displayed in those locations. As such, text locations may not be identified where the text would only appear rarely and/or would provide limited use if extracted (such as text which a user would not be particularly interested in).

The region identification unit 520 may be configured to identify the one or more regions based upon information extracted from a representative sample of frames from content from the same source (such as videos from a same content creator, or previous playthroughs of a same video game). For instance, as exemplified by the method of FIG. 3, such information can be extracted by an information extraction process including detecting text regions within the frames in the representative sample, collating those text regions into a single frame, and merging and/or deleting one or more of those text regions. The information extraction may further include generating a dictionary for each text region based upon an OCR process performed upon those text regions

The region modification unit 530 is configured to apply one or more color ranges to the identified regions such that colors outside of the color ranges are set to a default value, wherein the color ranges are defined based upon expected text colors. The default value may be any value outside of the color ranges; preferably this may be black (in the case that no black text is used in the content) or any color which is identified as being highly contrasting with one or more of the color ranges. These color ranges may be defined by a developer or content creator, for example, or may be derived using a process in accordance with that described with reference to FIG. 4. A color range may be defined to correspond to a particular font color, or may cover a group of similar colors (such as different shades of blue).

In some implementations it may be preferred that the region modification unit 530 is configured to convert the identified regions to an HSV color space. This may be performed before the application of the color ranges (in the case that the ranges are specified in the HSV color space), or after as appropriate for a given implementation.

In line with the discussion of the method of FIG. 4, it is considered that expected text colors may be determined in dependence upon color information extracted from a representative sample of frames from content from the same source. In such implementations, the color information may be extracted by a color information extraction process which includes performing OCR on one or more of the representative sample of frames, segmenting text pixels from background pixels, generating respective color palettes for each group of pixels, and comparing these color palettes to determine a range of text colors.

The text presence identification unit 540 is configured to identify the presence of text within the identified regions, and to identify one or more bounding areas (and their sizes) which each correspond with a respective identified text presence. As discussed with reference to step 230 of FIG. 2, a range of different approaches to identifying whether text is present (distinct from performing text or character recognition); in some implementations the text presence identification unit 540 is configured to use a maximally stable extremal regions (MSER) technique to identify the presence of text.

The size of the bounding areas can be determined in any preferred manner. In some instances, the smallest encompassing rectangle may be identified. Alternatively, a single dimension may be identified—such as a width or height of the identified text presence.

The bounding area evaluation unit 550 is configured to determine whether any of the one or more bounding areas exceeds a threshold size. The threshold size may be defined on the basis of a largest dimension, a particular dimension (such as width or height), or an area, for example.

If it is determined that none of the bounding areas exceeds the threshold size then processing, then it is assumed that any identification of the presence of text is erroneous or of limited significance (such as particularly short text, or text which is in the environment rather than in an overlay). In such cases, processing continues with the region identification unit 520 identifying one or more regions in the next obtained image frame. In other words, processing by the monitoring unit 560 and OCR unit 570 is not performed for this image frame and instead the next image frame (that is, the n^{th} image frame in the content from the present image frame) is processed.

However, if it is determined that at least one bounding area exceeds a threshold size processing of the image frame continues. In this case, the monitoring unit 560 is configured to cause the frame obtaining unit 510 to instead obtain a plurality of consecutive frames of content, and to monitor a number of consecutive frames in which the bounding area exceeds the threshold size. In this case, each of the region identification unit 520, region modification unit 530, text presence identification unit 540, and bounding area evaluation unit 550 are configured to perform their respective processing on each of the consecutive frames to enable the monitoring unit 560 to monitor changes to the bounding area. That is to say that the bounding area evaluation can be used to be performed for each frame in order to allow this condition to be monitored.

In other words, rather than obtaining every n^{th} frame it frame obtaining unit 510 is configured to obtain every frame in a sequence (or at least obtain frames more frequently by reducing the value of n, which may be particularly suitable for content with a high frame rate). The monitoring of the number of consecutive frames in which the bounding area exceeds the threshold size may be performed on a per-bounding-area basis, such that a separate count is maintained for each bounding area.

The OCR unit 570 is configured to perform an OCR process in the one or more bounding areas in which the threshold size is exceeded for at least a predetermined number of consecutive frames (should any of the bounding areas satisfy this condition), and to output recognised text. The predetermined number of frames may be defined in any preferred manner; such as selecting a number of frames in dependence upon a frame rate of the content and a minimum display time of text in the content. In some implementations the results of the OCR process are compared to a region-or content-specific dictionary to validate the recognised text prior to output.

In response to the OCR unit 570 performing an OCR process the monitoring unit 560 may be configured to monitor for changes in the bounding areas, and the OCR unit is configured to perform subsequent OCR processes only in the case that changes are observed. In other words, the OCR process may be suspended until it is determined that there is likely to be new text to be read in a given bounding area. Changes to the bounding area may include a change in size, and/or a change in properties identified by the text presence identification unit 540 (such as a text density or number of characters).

It is therefore considered that the processing of the system 500 is configured to proceed without OCR being performed for a number of frames after a successful OCR process is performed (that is, after a text extraction occurs). This means that the functional units 510, 520, 530, 540, 550, and 560 may perform their normal functions without proceeding to performing an OCR process until it is determined that new text is likely to be present in the image frames.

The extracted text resulting from the use of the OCR process may be used for a number of different purposes. In some cases, this can be used to monitor a state of the content (such as a user's equipment changes or health/ammunition levels in a game), to identify the occurrence of one or more events (such as the beginning of a new level in a game), or to monitor performance of a user in a game, for instance.

This approach may be particularly suitable when information output by the content itself (such as video metadata or game engine data) is not available or not sufficient. This may be the case in a cloud gaming arrangement for instance, in which it may be desirable for the client device to extract information from the video stream which would otherwise not be available to the client device. This can allow the client to perform specific processing, such as local HUD generation, audio description of the content, or the setting of video decoding parameters, based upon identified events within the content or the like. This can therefore improve the performance of the arrangement, as well as increase the level of functionality that can be offered by the client device in such an arrangement.

The arrangement of FIG. 5 is an example of a processor (for example, a GPU and/or CPU located in a games console or any other computing device) that is operable to perform an optical character recognition, OCR, process, and in particular is operable to:
obtain a plurality of image frames from video content during presentation, the plurality of image frames comprising every nth frame of the content where n is an integer greater than one;
identify, in an obtained image frame, one or more regions in which text may appear;
apply one or more color ranges to the identified regions such that colors outside of the color ranges are set to a default value, wherein the color ranges are defined based upon expected text colors;
identify the presence of text within the identified regions, and to identify the size of one or more bounding areas which each correspond with a respective identified text presence;
determine whether any of the one or more bounding areas exceeds a threshold size, wherein if it is determined that none of the bounding areas exceeds the threshold size then processing continues with the identification of one or more regions in the next obtained image frame;
cause, if it is determined that at least one bounding area exceeds a threshold size, the obtaining of a plurality of consecutive frames of content, and monitor a number of consecutive frames in which the bounding area exceeds the threshold size; and
perform an OCR process in the one or more bounding areas in which the threshold size is exceeded for at least a predetermined number of consecutive frames, and to output recognised text.

An example of a suitable computing device is the entertainment system 10 of FIG. 1, which comprises a CPU 20 and a GPU 30 which may be utilised to perform processing in accordance with the described functionality.

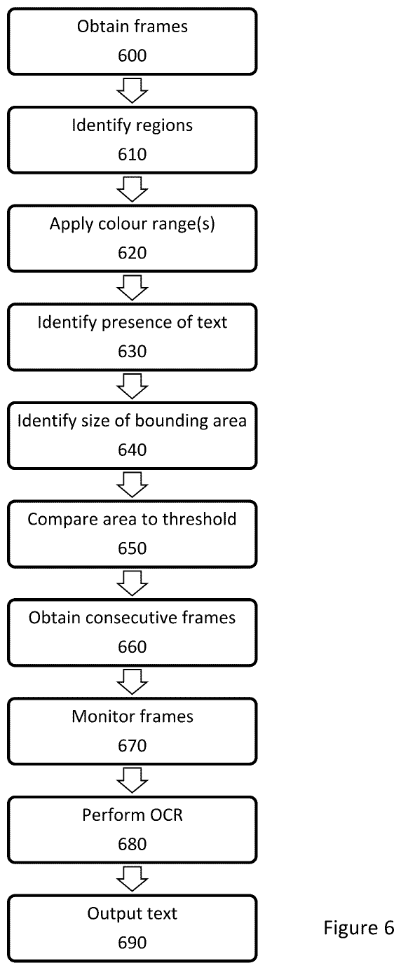

FIG. 6 schematically illustrates a method for performing an optical character recognition, OCR, process in accordance with the discussion of the system of FIG. 5. As noted above, this may be implemented by a CPU and/or GPU embodied in any suitable processing device, such as a computer, server, or games console.

A step 600 comprises obtaining a plurality of image frames from video content during presentation, the plurality of image frames comprising every nth frame of the content where n is an integer greater than one.

A Step 610 includes identifying, in an obtained image frame, one or more regions in which text may appear.

A step 620 includes applying one or more color ranges to the identified regions such that colors outside of the color ranges are set to a default value, wherein the color ranges are defined based upon expected text colors.

A step 630 includes identifying the presence of text within the identified regions.

A step 640 includes identifying the size of one or more bounding areas which each correspond with a respective identified text presence.

A step 650 includes determining whether any of the one or more bounding areas exceeds a threshold size, wherein if it is determined that none of the bounding areas exceeds the threshold size then the method returns to the step of identifying one or more regions in the next obtained image frame.

A step 660 includes obtaining, if it is determined that at least one bounding area exceeds a threshold size, a plurality of consecutive frames of content.

A step 670 includes monitoring a number of consecutive frames in which the bounding area exceeds the threshold size.

A step 680 includes performing an OCR process in the one or more bounding areas in which the threshold size is exceeded for at least a predetermined number of consecutive frames.

A Step 690 includes outputting recognised text.

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. A system for performing an optical character recognition, OCR, process, the system comprising:
a frame obtaining unit configured to obtain a plurality of image frames from video content during presentation, the plurality of image frames comprising every n^{th} frame of the content where n is an integer greater than one;
a region identification unit configured to identify, in an obtained image frame, one or more regions in which text may appear;
a region modification unit configured to apply one or more color ranges to the identified regions such that colors outside of the color ranges are set to a default value, wherein the color ranges are defined based upon expected text colors;
a text presence identification unit configured to identify the presence of text within the identified regions, and to identify the size of one or more bounding areas which each correspond with a respective identified text presence;
a bounding area evaluation unit configured to determine whether any of the one or more bounding areas exceeds a threshold size, wherein if it is determined that none of the bounding areas exceeds the threshold size then processing continues with the region identification unit identifying one or more regions in the next obtained image frame;
a monitoring unit configured to cause, if it is determined that at least one bounding area exceeds a threshold size, the frame obtaining unit to instead obtain a plurality of consecutive frames of content, and to monitor a number of consecutive frames in which the bounding area exceeds the threshold size; and
an OCR unit configured to perform an OCR process in the one or more bounding areas in which the threshold size is exceeded for at least a predetermined number of consecutive frames, and to output recognised text.

2. The system of claim 1, wherein the value of n is selected in dependence upon a frame rate of the content and information about the average and/or minimum display time for text within the content.

3. The system of claim 1, wherein the region identification unit is configured to identify the one or more regions in dependence upon a text file indicating region locations or an image mask which masks regions in which text does not appear.

4. The system of claim 1, wherein the region modification unit is configured to convert the identified regions to an HSV color space.

5. The system of claim 1, wherein the text presence identification unit is configured to use a maximally stable extremal regions, MSER, technique to identify the presence of text.

6. The system of claim 1, wherein in response to the OCR unit performing an OCR process the monitoring unit is configured to monitor for changes in the bounding areas, and the OCR unit is configured to perform subsequent OCR processes only in the case that changes are observed.

7. The system of claim 1, wherein the results of the OCR process are compared to a region-or content-specific dictionary to validate the recognised text prior to output.

8. The system of claim 1, wherein the region identification unit is configured to identify the one or more regions based upon information extracted from a representative sample of frames from content from the same source.

9. The system of claim 8, wherein the information is extracted by an information extraction process comprising detecting text regions within the frames in the representative sample, collating those text regions into a single frame, and merging and/or deleting one or more of those text regions.

10. The system of claim 9, wherein the information extraction further comprises generating a dictionary for each text region based upon an OCR process performed upon those text regions.

11. The system of claim 1, wherein expected text colors are determined in dependence upon color information extracted from a representative sample of frames from content from the same source.

12. The system of claim 11, wherein the color information is extracted by a color information extraction process which comprises performing OCR on one or more of the representative sample of frames, segmenting text pixels from background pixels, generating respective color palettes for each group of pixels, and comparing these color palettes to determine a range of text colors.

13. A method for performing an optical character recognition, OCR, process, the method comprising:
obtaining a plurality of image frames from video content during presentation, the plurality of image frames comprising every n^{th} frame of the content where n is an integer greater than one;
identifying, in an obtained image frame, one or more regions in which text may appear;
applying one or more color ranges to the identified regions such that colors outside of the color ranges are set to a default value, wherein the color ranges are defined based upon expected text colors;
identifying the presence of text within the identified regions;
identifying the size of one or more bounding areas which each correspond with a respective identified text presence;
determining whether any of the one or more bounding areas exceeds a threshold size, wherein if it is determined that none of the bounding areas exceeds the threshold size then the method returns to the step of identifying one or more regions in the next obtained image frame;
obtaining, if it is determined that at least one bounding area exceeds a threshold size, a plurality of consecutive frames of content;
monitoring a number of consecutive frames in which the bounding area exceeds the threshold size;
performing an OCR process in the one or more bounding areas in which the threshold size is exceeded for at least a predetermined number of consecutive frames; and
outputting recognised text.

14. The method of claim 13, wherein the value of n is selected in dependence upon a frame rate of the content and information about the average and/or minimum display time for text within the content.

15. The method of claim 13, wherein the region identification unit is configured to identify the one or more regions in dependence upon a text file indicating region locations or an image mask which masks regions in which text does not appear.

16. The method of claim 13, wherein the region modification unit is configured to convert the identified regions to an HSV color space.

17. One or more non-transitory computer storage media storing instructions that when executed by one or more computers cause the one or more computers to perform operations for performing an optical character recognition, OCR, process, the operations comprising: obtaining a plurality of image frames from video content during presentation, the plurality of image frames comprising every n^{th} frame of the content where n is an integer greater than one;
identifying, in an obtained image frame, one or more regions in which text may appear;
applying one or more color ranges to the identified regions such that colors outside of the color ranges are set to a default value, wherein the color ranges are defined based upon expected text colors;
identifying the presence of text within the identified regions;
identifying the size of one or more bounding areas which each correspond with a respective identified text presence;
determining whether any of the one or more bounding areas exceeds a threshold size, wherein if it is determined that none of the bounding areas exceeds the threshold size then the method returns to the step of identifying one or more regions in the next obtained image frame;
obtaining, if it is determined that at least one bounding area exceeds a threshold size, a plurality of consecutive frames of content;
monitoring a number of consecutive frames in which the bounding area exceeds the threshold size;
performing an OCR process in the one or more bounding areas in which the threshold size is exceeded for at least a predetermined number of consecutive frames; and
outputting recognised text.

18. The one or more non-transitory computer storage media of claim 17, wherein the value of n is selected in dependence upon a frame rate of the content and information about the average and/or minimum display time for text within the content.

19. The one or more non-transitory computer storage media of claim 17, wherein the region identification unit is configured to identify the one or more regions in dependence upon a text file indicating region locations or an image mask which masks regions in which text does not appear.

20. The one or more non-transitory computer storage media of claim 17, wherein the region modification unit is configured to convert the identified regions to an HSV color space.
